(19) United States
(12) Patent Application Publication
(10) Pub. No.: US 2007/0174904 A1
(43) Pub. Date: Jul. 26, 2007

(54) One-time password service system using mobile phone and authentication method using the same

(75) Inventor: Nool Park, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/581,280

(22) Filed: Oct. 16, 2006

(30) Foreign Application Priority Data
Jan. 24, 2006 (KR) 2006-0007178

(51) Int. Cl. G06K 9/00

(52) U.S. Cl. 726/7

(57) ABSTRACT

Disclosed is a one-time password (OTP) service system and method for generating and authenticating an OTP using a mobile phone, the system includes a OTP server for generating a query(a) for an authentication to transmit, receiving a response OTP password N corresponding to the query(a), generating an OTP M corresponding to the query(a), and performing an authentication when the OTP M corresponds to with the response password N; a short message service SMS server for converting the query(a) transmitted from the OTP server into a text message for transmission; an OTP mobile phone for detecting the query(a) in the transmitted SMS message and generating and displaying the response password N; a personal communications device which transmits the response password N to the OTP server when the response password N on the transmitted query(a) from the OTP server is input; and a content offer server for providing a corresponding content to the personal communications device according to the results of the authentication.

### PRIORITY

This application claims priority under 35 U.S.C. §119 to an application entitled “ONE-TIME PASSWORD SERVICE SYSTEM USING PORTABLE PHONE AND CERTIFYING METHOD USING THE SAME,” filed in the Korean Intellectual Property Office on Jan. 24, 2006 and assigned Serial No. 10-2006-0007178, the contents of which are incorporated herein by reference.

### BACKGROUND OF THE INVENTION

1. Field of the Invention

The present invention relates to a one-time password service system and authentication method thereof and more particularly, to a system and method for generating and authenticating a one-time password using a mobile phone.

2. Description of the Background Art

Recently, the use of an online Internet banking system for services such as finance, stock trading and home trading system (HTS) has become popular. However, the security and systems for these services can vary. For example, various authentication procedures may be required for using services such as finance, stock trading, and HTS. Accordingly, a security certification system has been developed to provide appropriate levels of security.

Conventional security and/or access methods require a user to input an ID and password to confirm the user in each content provider server available in a wire and/or wireless Internet environment. However, such method has an inconvenience in that an ID and password set up is required in order to use each service. Further, users must memorize (or have otherwise saved for later access) access information such as the ID and password. Moreover, when the user loses either or both the ID or password, a process for obtaining and/or resetting them is troublesome. Moreover, it is well known that users typically use the same ID and/or password for most sites. Thus, if a single password is released (i.e., made public), the security of a user's personal information can be jeopardized.

Therefore, in order to use the online financial service requiring security certification, the user should establish a complicated password formed using many characters and/or numbers, or should perform an authentication procedure by issuing a certificate and perform a constituent confirmation process with a secure card, which can be inconvenient.

An one-time Password (OTP) method is a representative method for securing the security relating to authentication for using the service with the content described above and providing a convenience for the user. The one-time password method is a mode where a different password is generated each time a password is used as opposed to inputting a fixed password. In other words, the OTP is a randomly generated password and is different each time it is used.

The one-time password method uses 128 bit message contraction from. input data, producing the one-time password using a Hashing function algorithm used for verifying the integrity of data.

In the one-time password method, a query/ response or challenge/response mode and a time synchronization mode techniques are typically used.

FIG. 1 is a block diagram illustrating a one-time password service system for a conventional security certification.

As shown in the FIG. 1, the one-time password service system includes a one-time password OTP terminal 10, a personal computer 20, a content offer server 30 and a one-time password OTP server 40.

The one-time password OTP terminal 10 generates a random one-time password corresponding to a received query input. The personal computer 20 connects to the content offer server 30 through the Internet network 50, and is provided with content through the authentication of the one-time password. The content offer server 30 provides the authenticated user in the personal computer 20 connected through the Internet network 50 with various contents. The one-time password OTP server 40 generates a query required for the authentication of the user through the personal computer 20 and the one-time password using it.

In the query/response method, the OTP server 40 transmits a query to the user through the personal computer 20. The user of the personal computer 20, then using the query, generates the OTP using the OTP terminal 10, and submit the OTP through the personal computer 20 to the OTP server 40. For this, the user inputs the query into the OTP terminal 10 and when the OTP is output, the user submits the password to the OTP server 40 through the personal computer 20 to receive a certification.

The time synchronization method is a mode where an OTP is generated during a predetermined time period and, thus, a certification is given. For this, a time limit, for example, 30 seconds, may be established. Within this time period, the OTP server 40 and the OTP terminal 10 belonging to user generate the same password according to an established time synchronization to authorize the user.

FIG. 2 is a diagram illustrating a secure authentication method using the query/response method of the one-time password system of FIG. 1.

As shown, the personal computer 20 is connected to the content offer server 30 through the Internet network 50 (S11). At this time, the content offer server 30 provides the personal computer 20 with a Web page for a content offer.

According to the input command, the personal computer 20 requests an offer of content (i.e., a content request) using the Web page provided by the providing server 30 (S13). The content offer server 30 then informs the OTP server 40 that an authentication is required for the personal computer 20 (S15). At this time, the OTP server 40 generates a query (S17), transmits the generated query to the personal computer 20 through the content offer server 30 and requests a password corresponding to the query (S19 and S21, respectively).

Accordingly, the personal computer 20 displays the received query and requests a password corresponding to the query (S23). In the meantime, the OTP server 40 (in (S25) generates the one-time password “A” corresponding to the query generated in step (S17).

A use permission number for allowing the use of the OTP terminal 10 is input to the OTP terminal 10 by the user (S31). If use is allowed according to the input of the use permission number, the query (provided from the OTP server 40) is input to the OTP terminal 10 (S33). Accordingly, the OTP terminal 10 generates a one-time password “B” corresponding to the query (S35).

The password “B”, generated in the OTP terminal 10, is then transmitted to the personal computer 20 (S41). Then, the personal computer 20 transmits the generated password “B” to the OTP server 40 as a response password of the query of the OTP server 40 through the contents offer server 30 (S43 and S44).

The OTP server 40 then performs an authentication procedure where the one-time password B submitted from the personal computer 20 is compared with the one-time password “A” generated in step (S25) and determines whether the OTPs “A” and “B” are identical (S45). If the OTP “A” coincides with the OTP “B”, the OTP server 40 transmits authentication success information to the content offer server 30 (S47). Accordingly, the content offer server 30 provides the content demanded in the step (S13) to the personal computer 20 (S49). But, if the OTP “A” does not coincide with the OTP “B”, the OTP server 40 transmits authentication failure information to the content offer server 30 (S51). Accordingly, in step (S13), the content offer server 30 transmits authentication failure information corresponding to the content request to the personal computer 20 (S49).

The query/response method has the advantage that synchronization between the OTP terminal 10 and the OTP server 40 is not required. However, there is an inconvenience that, generally, the user should input a four-digit password for the OTP terminal 10, and should input a six-digit query provided by the OTP server 40.

However, because the time synchronization method does not require the query as required by the query/response method, the number of inputs by the user for the password generation can be reduced. However, there is a problem in that the authentication fails if the one-time password generated in the OTP terminal 10 is not inputted within the predefined time period.

In addition, in order to use the query/response method and the time synchronization method as described above, an OTP terminal 10 is required for an authentication. Accordingly, the user's subject to the additional cost of purchasing the OTP terminal (hereinafter, an OTP-only terminal). Moreover, there is an inconvenience that the OTP terminal 10 must be carried in order to receive the certification by using the conventional query/response method and the time synchronization method.

### SUMMARY OF THE INVENTION

Accordingly, an object of the present invention is to solve at least the problems and disadvantages of the prior art.

Thus, it is an object of the present invention to provide a one-time password service (OTP) system and method for conveniently providing mobility and usage of an OTP terminal generating an OTP corresponding to a received query when using an OTP authentication method.

It is, another object of the present invention to provide an OTP service system and method for conveniently generating and using an OTP for an authentication without requiring the use of an OTP-only terminal generating one-time password corresponding to the query value.

Still another object of the present invention is to provide an OTP service system and method using a mobile phone which is capable of producing an OTP corresponding to a query, for performing the one-time password authentication.

It is yet another aspect of the present invention to provide a system and a method for providing and using a one-time password (OTP), the system including an OTP server for generating a query(a) for an authentication to transmit, receiving a response password N to the query(a), generating an OTP M through the query(a), and performing the authentication when the OTP M corresponds to the response password N; a short message service (SMS) server for converting the query(a) transmitted from the OTP server into a text message for transmission and transmitting the text message ; an OTP mobile phone for detecting the query(a) in the text message received from the SMS server and generating and displaying the response password N; a personal communications device for transmitting the response password N to the OTP server when the response password N on the transmitted query(a) from the OTP server is inputted; and a content offer server for providing corresponding content o the personal communications device according to the authentification of the OTP server.

According to another aspect of the present invention a method for providing and using an OTP includes generating a query(a) for an authentication required to provide content in an OTP server, transmitting the query(a) to a personal communications device and an SMS server, and generating an OTP M by using the query(a); transforming the query(a) transmitted from the OTP server into a text message in the SMS server, and transmitting the text message to the OTP mobile phone; detecting the query(a) in the text message transmitted from the SMS server in the OTP mobile phone, and generating a response password N using the query(a); transmitting the response password N corresponding to the query(a) to the OTP server when the response password N is input into the personal communications device; receiving the response password N in the OTP server and performing the authentication when the response password N is identical with the one-time password M; and selectively providing corresponding content from the content offer service to the personal communications device according to the success of the authentication.

According to still another aspect of the present invention a device and method for detecting querys in text messages includes a text message identifier for detecting and determining a type of a text message, the text message being classified by use based on an identification value included in the text message when the text message is transmitted from an SMS server, and identifying whether the text message includes a query(a); a query detector for detecting the query(a) from the text message when the query(a) is included in the text message; a password generator generating a response password N that is an OTP based on the detected query(a) and identifying information(b)allocated to a OTP mobile phone; and a display unit indicating the response password N.

According to another aspect of the present invention, an OTP server generates and transmits a query(a) to an OTP mobile phone through an SMS server in a message having a short-message format, if an authentification is required before content is to be transmitted to a user. The OTP mobile phone obtains the query(a) from the received message, generates an OTP and inputs the OTP to a personal computer, thereby submitting the OTP to the OTP server as a response password. Accordingly, the response password according to the query of the OTP server can be conveniently generated using the OTP mobile phone capable of generating the OTP.

### BRIEF DESCRIPTION OF THE DRAWINGS

The invention will be described in detail with reference to the following drawings in which like numerals refer to like elements.

FIG. 1 is a block diagram illustrating a one-time password (OTP) service system for a conventional security certification;

FIG. 2 is a flowchart illustrating an authentication method using the query/response method in the OTP system of FIG. 1;

FIG. 3 is a block diagram illustrating an OTP service system using a mobile phone according to the present invention;

FIG. 4 is a detailed block diagram illustrating the content offer server shown in FIG. 3;

FIG. 5 is a detailed block diagram illustrating the OTP server shown in FIG. 3;

FIG. 6 is a detailed block diagram illustrating the OTP mobile phone shown in FIG. 3 and;

FIG. 7 is a flowchart illustrating the OTP service method using a mobile phone according to the present invention.

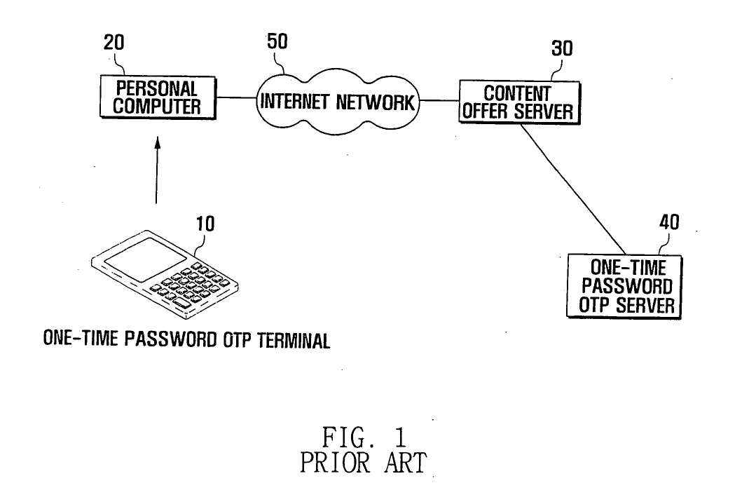

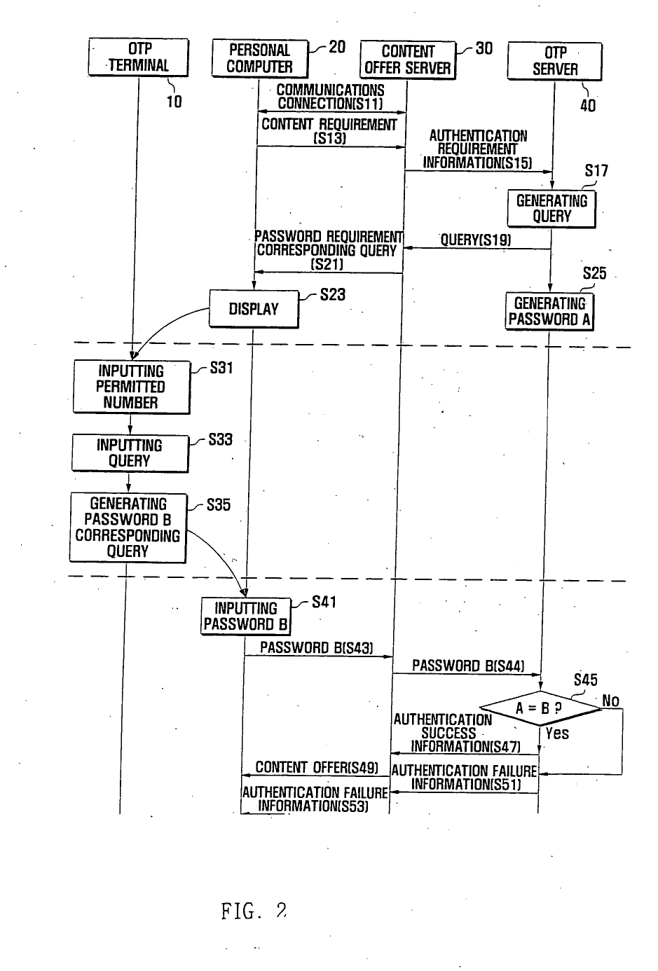

### DETAILED DESCRIPTION OF THE PREFERRED EMBODIMENTS

Preferred embodiments of the present invention will be described in a more detailed manner with reference to the attached drawings.

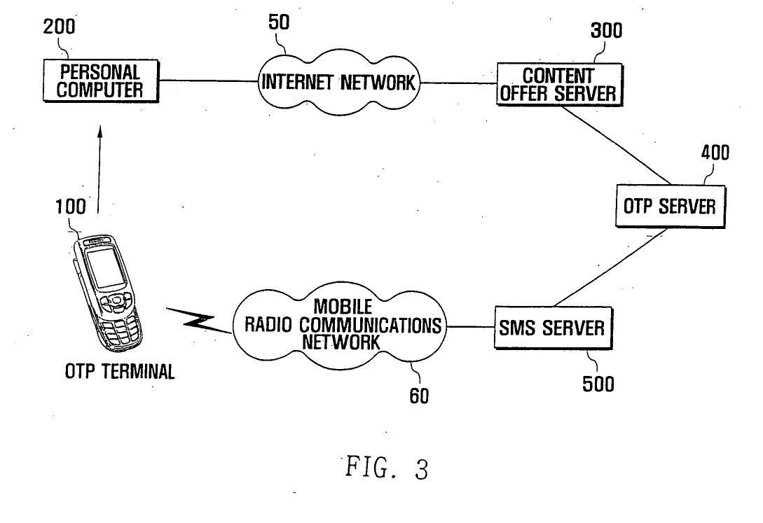

FIG. 3 is a block diagram illustrating the OTP service system using a mobile phone according to the present invention. As shown, the OTP service system includes an OTP terminal (e.g., an OTP cellular phone) a palm type device, etc.) 100 having an OTP generating function, a personal computer 200, a content offer server 300, an OTP server 400, and an SMS server 500.

The personal computer 200 is connected to the content offer server 300 through a network such as an Internet network 50, while the SMS server 500 is connected to the OTP cellular phone 100 through a mobile radio communications network 60.

The OTP cellular phone 100 supports voice and data mobile communications through the mobile radio communications network 60, generating an OTP corresponding to a received query by using hash function algorithm or encryption algorithm according to the present invention. The algorithms and the OTP generating step are well known in the art. Accordingly, for the sake of clarity, a detailed description of these algorithms or the OTP generating step will not be described in detail herein.

The personal computer 200, is connected to the content offer server 300 through the Internet network 50, and displays the web page provided from the content offer server 300. The personal computer 200 transmits an input OTP (that is generated according to the query received from the OTP server 400) to the OTP server 400 via the content offer server 300 through the Internet network 50. Moreover, according to the authentification result through the OTP, the personal computer 200 receives content provided from the content offer server 300 and outputs it through a user interface (such as speaker, display, etc.).

The content offer server 300 manages the content and user information required for receiving the corresponding content. When the personal computer 200 or the cellular phone 100, capable of connecting to the Internet, requests the content, the content offer server 300 transmits the authentification requirement information, including a telephone number allocated to the OTP cellular phone 100, to the OTP server 400. The content offer server 300 then receives the query corresponding to the authentification requirement information from the OTP server 400 and transmits the query (query (a)) to the personal computer 200. Further, the content offer server 300 receives a password in response to the query from the personal computer 200 and transmits the password to the OTP server 400. The content offer server 300 selectively provides the requested content to the personal computer 200 based on a the password authentication result performed by the OTP server 400.

The OTP server 400 (in association with the content offer server 300), manages user information registered in the content offer server 300, and generates the query (a) if authentification requirement information is received from the content offer server 300 and thereafter transmits the query(a) to the SMS server 500. It is preferable that the OTP server 400 transmits the query(a) including the phone number (query a) information of the OTP mobile phone 100. In the meantime, the OTP server 400 generates the OTP based on the generated query(a) and the information of the user who requested the content. Further, the OTP server 400 determines whether the received response password coincides with the OTP generated by the OTP server 400, and transmits a result of the determination to the content offer server 300.

The SMS server 500 converts the query(a) received from the OTP server 400 into the short-message-type format, and transmits the generated short message to the OTP cellular phone 100 through the mobile radio communications network 60 using the information of phone number included in the query.

Accordingly, the OTP cellular phone 100 receives the short message transmitted from the SMS server 500 and determines the type of the message. Preferably, as illustrated in Table 1 below, the OTP cellular phone 100 can determine a type of the message based on an identification value. For example, as illustrated in Table 1, the value “44100” is assigned to indicate a query required for the authentification using an OPT.

TABLE 1

| IS-637 Teleservice | IS-41 Teleservice | Value |
|---|---|---|
| IS-91 Extended Protocol Enhanced Service | CMT-91 | 4096 |
| Mobile Paging Teleservice | CPT-95 | 4097 |
| Mobile Messaging Teleservice | CMT-95 | 4098 |
| Voice Mail Notification | VMN-95 | 4099 |
| OTP Challenge Notification | | 4100 |

The SMS server 500 transmits the short message (corresponding to the query(a)) with the identification value “4100”. Therefore, the OTP terminal 100, when recognizing the identification of value “4100”, determines that the received short message includes the query(a). Accordingly, the OTP cellular phone 100 obtains the query(a) included in the received short message and generates an OTP password corresponding to the received query(a) it. Preferably, the OTP cellular phone 100 uses a hashing function algorithm h(a,b) to generate the corresponding OTP by using the query(a) and the allocated telephone number (b).

If the OTP generated in the OTP terminal 100 is input, by the user, into the personal computer 200, the personal computer 200 transmits the input OTP to the OTP server as a response password of the query(a) via the content offer server 300. Therefore, if the authentification is required for providing content to the user, the OTP server 400 generates the query(a) transmits the query(a) with to the OTP cellular phone 100 in a short-message-format through the SMS server 500.

The OTP terminal 100 obtains the query(a) from the received short message and generates the corresponding OTP. Thus, the OTP can be input to the personal computer 200, and thereafter transmitted to the OTP server 400 as a response password. By using the OTP the response password according to the query(a) of the OTP server can be conveniently generated.

Accordingly, the response password corresponding to the query(a) is automatically and rapidly generated and provided by using the OTP terminal 100.

In addition, the OTP 100 generates the OTP for a response by using the hashing function h(a,b) which has factor including the query(a) included in the short message and a unique telephone number (b) allocated to the cellular phone. Thus, although an identical algorithm is used to generate the OTP in the OTP terminal 100, a response password having high security and reliability can be generated, because different telephone numbers will generate different OTPs. Accordingly, a query(a) sent to another OTP terminal will generate a different OTP.

Furthermore, when the OTP server 400 performs the authentication procedure according to the determination on identification of the OTP, the procedure of discriminating each of the OTP terminals that generated the response password as is done using conventional methods is not required. In this case, the procedures of generating the OTP and authenticating the one-time password corresponding to the telephone number allocated to OTP terminal 100 may be performed to simplify an authentication procedure from both a system and user's standpoint.

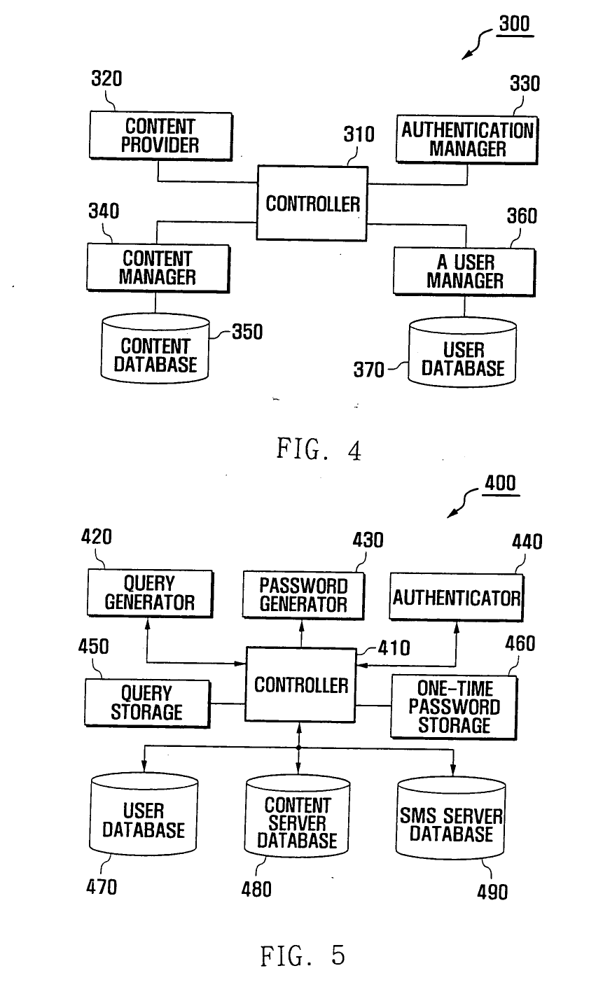

FIG. 4 is a detailed block diagram illustrating a content offer server shown in FIG. 3. As shown, the content offer server 300 includes a controller 310, a content provider 320, an authentication manager 330, a content manager 340, a content database 350, a user manager 360 and a user database 370.

The controller 310 controls the overall operation of the content offer server 300, controlling information related to offered content and/or to the content offer server 300 to be displayed on a Web page related to the content offer server 300 and the content offerings in accordance with an authentication by the connected personal computer 200.

The content provider 320 provides the content requested by the personal computer 200 under the control of the controller 310. The authentication manager 330 controls the authentication (for example, it generates an authentication result) and the information necessary for the authentication corresponding to the offered content, and transmits information related to the authentication to the OTP server 400 through the controller 310.

The content manager 340 manages the content database 350 where the content is stored. The user manager 360 manages the user database 370 where the user information is stored while the user information is registered in the content offer server 300.

According to the authentication result of the authentication manager 330, if the controller 310 determines that the authentication is required for the content offer, the controller 310 transmits the authentication requirement information to the OTP server 400. At this time, the telephone number allocated to the OTP cellular phone 100 of a user may be included in the authentication requirement information. Further, the controller 310 can share the user information stored in the user database 370 which can include user information such as a user's name, account number, account history, service class, OTP terminal identification number (e.g., telephone number), etc. managed by the user manager 360 with the OTP server 400.

The controller 310 transmits information requiring the response password corresponding to the query transmitted from the OTP server 400 to the personal computer 200 in accordance with the authentication requirement information. The controller 310 transmits the response password transmitted from the personal computer 200 to the OTP server 400. According to the authentification result of the OTP server 400, the controller 310 selectively provides the content to the personal computer 200.

FIG. 5 is a detailed block diagram illustrating the OTP server of FIG. 3. As shown, the OTP server 400 includes a controller 410, a query generator 420, a password generator 430, an authenticator 440, a query storage area 450, an OTP storage 460, a user database 470, a content server database 480, and an SMS server database 490.

The controller 410 controls the overall operation of the OTP server 400, controlling the generation of the query, the generation of the OTP using the query, and the authentification procedure determining the match of the OTP generated by the OTP terminal 100 transmitted from the personal computer 200 based on the generated OTP according to the present invention.

According to the authentication requirement information transmitted from the content offer server 300, the query generator 420 generates the query to receive an OTP from the personal computer 200. The controller 410 transmits the generated query to the personal computer 200 by the OTP terminal 100 via the SMS server 500 or by the content offer server 300. At this time, the controller 410 stores the query generated in the query generator 420 into the query storage area 450.

The password generator 430 generates the using a hashing function algorithm with the factor that is the query generated in the query generator 420 and the telephone number allocated to the OTP terminal 100. At this time, the controller 410 stores the one-time password generated in the password generator 430 in the OTP storage area 460 (e.g., RAM, ROM, flash memory, hard-drive storage, etc.).

The authenticator 440 performs the authentication that compares the match of the OTP generated in the password generator 430 with the OTP generated in the OTP terminal 100 and transmitted from the personal computer 200. The controller 410 transmits the authentication success/failure (i.e., a determination result) of the authenticator 440 to the content offer server 300, thereby determining the offer of the content.

The user database 470 shares the user information registered in the content offer server 300, and stores and/or manages. Therefore, the information of phone number allocated to the OTP terminal 100 can be included in the user information. The content server database 480 stores and manages the information of the content offer servers including the contents offer server 300 which provides the content requiring an authentication. The SMS server database 490 stores and manages the information on a corresponding SMS server including the SMS server 500 of a mobile carrier in which a corresponding OTP terminal 100 is subscribed.

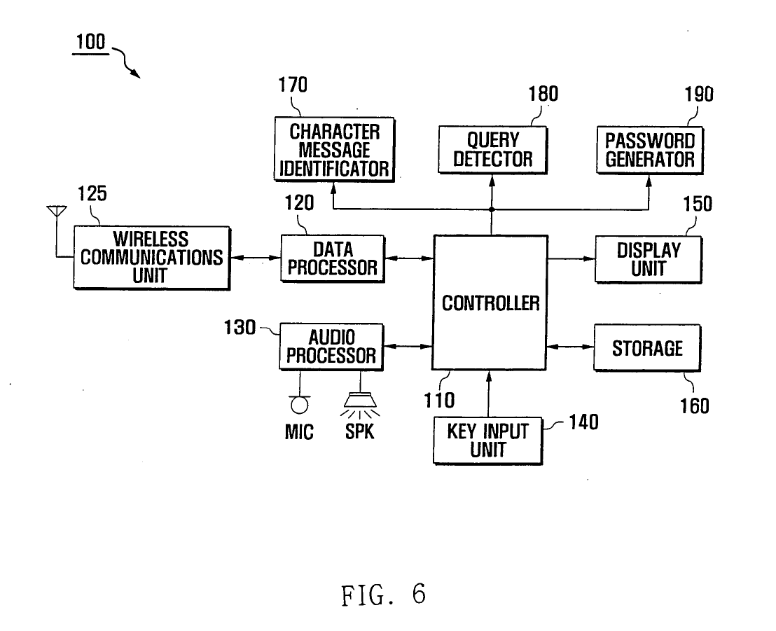

FIG. 6 is a detailed block diagram illustrating the OTP terminal shown in FIG. 3. As shown, the OTP cellular phone 100 includes a controller 110, a data processor 120, a wireless communications unit 125, an audio processor 130, a key input unit 140, a display unit 150, a storage area (e.g., RAM, ROM, flash memory, hard-drive, etc.) 160, a character message identificator 170, a query detector 180, and a password generator 190.

The controller 110 performs the overall control of the OTP terminal 100. The controller 110 controls data and voice communications with other devices through the data processor 120, the wireless communications unit 125, and/or the audio processor 130. Furthermore, the controller 110 controls the operation of sending and receiving text messages, voice messages, multimedia messages and video messages with other devices through a wireless radio channel the wireless communications unit 125. According to the using the present invention, the controller 110 receives a text message corresponding to the query(a) (i.e., a query text message) transmitted from the SMS server 500 through the wireless communications unit 125, and controls the generation of a corresponding OTP using the received query text message.

The data processor 120 includes a transmission module encodes and modulates a signal for transmission through a wireless radio channel and a receive module decodes and demodulates a received signal. According to the present invention, the data processor 120 demodulates the query text message received from the SMS server 500 through the mobile radio communications network 60, and provides the query text message to the controller 110.

The wireless communications unit 125 performs transmission/reception functions for the radio communications of the OTP terminal 100. The wireless communications unit 125 may include an RF (radio frequency) transmitter for upconverting and amplifying a signal to be transmitted, and an RF receiver for down converting and amplifying a low received signal. The wireless communications unit 125 receives the query text message transmitted from the SMS server 500 through the mobile radio communications network 60, and provides the query text message to the data processor 120.

The audio processor 130 may include a Coder/Decoder (CODEC). The CODEC can include a data codec for processing packet data, and an audio codec for processing audio signals including voice. The audio processor 130 converts the digital audio signal received in data processor 120 into an analog signal through the audio codec for output through a speaker. Furthermore, the audio processor 130 can convert analog audio signals input from a microphone into a corresponding digital audio signal using the audio codec, and can provide the digital audio signal to the data processor 120 through the controller 110. In this case, the CODEC may integrated within the controller 110.

The key input unit 140 includes a plurality of keys allowing a user to input number and/or character information and control keys for the controlling the operation of the OTP terminal 100. The key input unit 150 according to the present invention includes keys for inputting a display command and/or storing a generated OTP one-time password received through the query text message received from the SMS server 500.

The display unit 150 indicates the status information in accordance with the operation of the OTP cellular phone 100 under the control of the controller 110. The display 150 can include a Liquid Crystal Display (LCD). Accordingly, the display unit 210 may include a LCD controller, a memory capable of storing video data, etc. as necessary to support the display device. The display can also include touch screen mode, such that the display can also operate as an optional input interface. The display unit 150 according to the present invention can indicate the OTP generated using the received query text message, under the control of the controller 110. In addition, the display unit 150 may display a stored OTP password according to the command of the controller 110.

The storage area 160 may include program memory and data memory areas for optionally storing corresponding programs. For example, the program memory area may include programs for controlling the general operation of the OTP 100 and programs for the generation of the OTP through the query text message according to the present invention. According to the present invention, the storage 160 may store the received query text message and the OTP generated through the message.

The character message identificator 170 determines the type of the received text message based on the established identification value per use. Accordingly, the character message identificator 170 can determine whether the received text message includes the query based on the established identification value per use.

If the received text message according to the determination of the character message identificator 170 is determined to be a query text message, the query detector 180 detects the query from the received query text message by parsing.

The password generator 190 generates an OTP corresponding to a received query(a) using the hashing function h(a,b).

The controller 110 displays the OTP generated in the password generator 190 on the display unit 150. At this time, the controller 110 can temporarily and/or permanently store the generated OTP in the storage area.

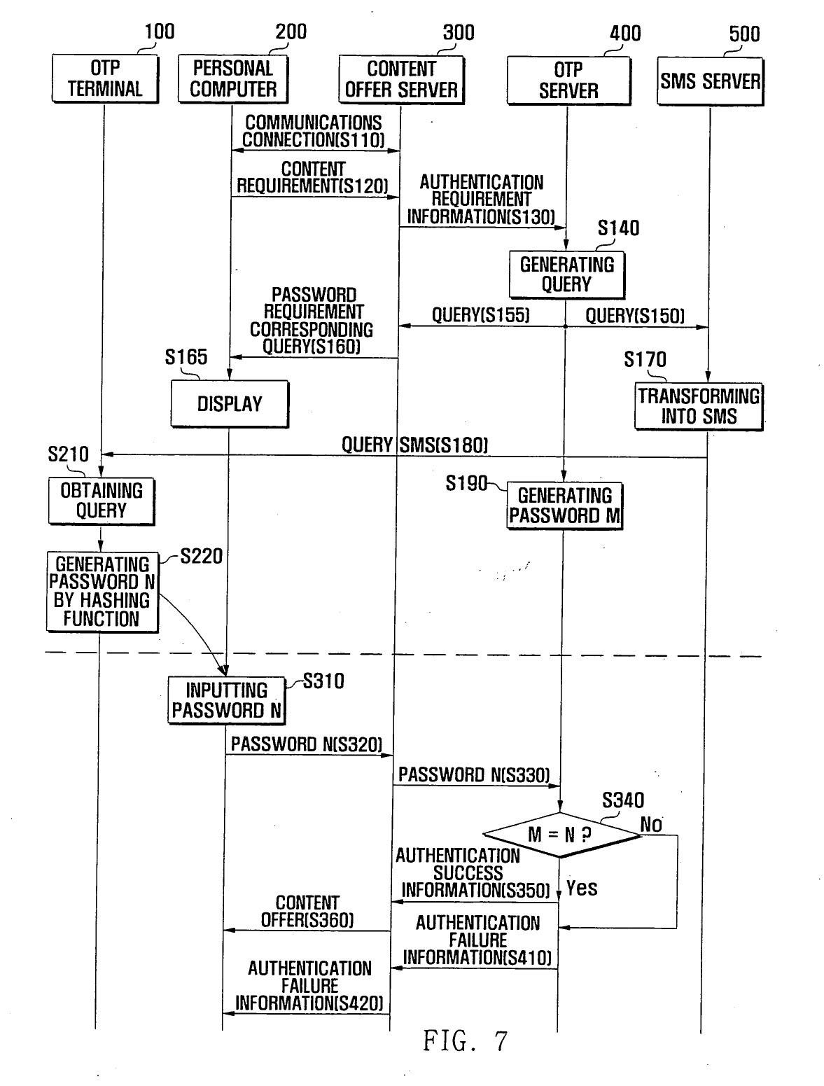

FIG. 7 is a flowchart illustrating an OTP service method using a mobile phone for the OTP terminal according to the present invention. The personal computer 200 connects to the content offer server 300 in step S110. The content offer server 300 then provides information including a content offer to the personal computer 200 via for, example, a Web page, or other message type.

The personal computer 200 requests content according to a user's command in step 120. For example, a user can request content offered by a Web page provided by the content offer server 300 by selecting a request button corresponding to the requested content that is displayed on the Web page. However, it is also envisioned that the user can use a menu-based display, etc. to review and/or request the offered content. Moreover, other GUI (graphical user interface) applications may be used. The content offer server 300 notifies the OTP server 400 that authentication is required for the request of the personal computer 200 in step S130.

The OTP server 400 generates the query corresponding to the authentication requirement information in step S140, transmits the generated query to the personal computer 200 through the content offer server 300 to require the password corresponding to the generated query in steps S155 and S160. Further, the OTP server 400 also transmits the generated query to the SMS server 500 in step S150.

The personal computer 200 displays the generated query transmitted from the OTP server 400 and requests information of the password corresponding to the query in step SI 65. The SMS server 500 transforms the query transmitted from the OTP server 400 into a short message (i.e., an SMS message) S170, and transmits the SMS message to the OTP terminal 100 through the mobile radio communications network 60 in step SI 80. In the meantime, the OTP server 400 generates OTP M through a hashing function using the query generated in the step S140 and information of a phone number allocated to the OTP terminal 100 in step S190.

The OTP terminal 100 receives the query short message (SMS message) transmitted from the SMS server 500 in step S1 80, and detects a query value in step S 210. The OTP terminal 100 generates an OTP N through the hashing function based on the obtained query (i.e., query(a)) and the information of the phone number allocated to OTP terminal 100 in step S220.

If the OTP N generated in the OTP cellular phone 100 is input in step S310, the personal computer 200 transmits a response password N of the received query(a) to the OTP server 400 through the content offer server 300 in steps S320 and S330.

The OTP server 400 then performs an authentication procedure where the OTP M generated in step S190 is compared with the OTP password N transmitted from the personal computer 200 to determine whether they correspond with each other (e.g., they are identical) in step S340.

If the OTP M corresponds with the OTP password N, which indicates success, the OTP server 400 transmits authentication success information to the content offer server 300 S 350. Accordingly, the content offer server 300 provides the requested content information to the personal computer 200 of the user in step S360. In the meantime, if the OTP M does not correspond with the OTP N in step S340, and the OTP server 400 transmits authentication failure information to the personal computer 200 through the content offer server 300 in steps S410 and S420.

Accordingly, the OTP server 400 generates the query(a), and transmits to the OTP cellular phone 100 through the SMS server 500 in an SMS-type format, and generates the OTP M using the query(a) n and the telephone number of the OTP terminal 100. If the OTP terminal 100 obtains the query(a) from the SMS message, generates the OTP one N. The OTP password can then be transmitted via the personal computer 200 to the OTP server 400 as a response password. Thus, the authentication procedure is performed when the OTP N coincides with the OTP one M. Therefore the response password (i.e., OTP N) according to the query of the OTP server can generated and provided by using the OTP terminal 100 such as a cellular phone capable of generating the OTP through the authentication procedure according to the present invention.

According to the present invention, if the authentication is required for the offer of content to the user, the OTP server generates the query (i.e., query(a), and transmits the query(a) to the OTP terminal through the SMS server in an SMS message. The OTP terminal obtain the query from the received SMS message, generates the user can then input the OTP password generated by the OTP terminal into the personal computer to transmit the OTP password to the OTP server as a response password. As such, the response password according to the query of the OTP server is conveniently generated and provided, using the OTP terminal capable of generating the OTP. Accordingly, by using the OTP terminal, the response password corresponding to the query can be conveniently, automatically, and rapidly generated to provide requested services to the user.

In addition, the OTP cellular phone 100 generates the OTP for response, by using the hashing function h(a,b) which has factor of the query(a) included in the SMS message and of the unique telephone number (b) allocated to the cellular phone. In that way, although the same algorithm is used in order to generate the in the OTP terminal, the password having high reliability and security can be generated.

Furthermore, when the OTP server performs the OTP authentication procedure according to the identification determination, without determining each of the OTP terminal generating the response password, the generation and the authentication procedure of the OTP is performed with the telephone number allocated to the OTP cellular phone. In that way, authentication procedure can be simplified.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An one-time password service system comprising:
an one-time password (OTP) server for generating and transmitting a query(a) for an authentication to transmit, receiving a response password N corresponding to the query(a), generating a one-time password M corresponding to the query(a), and performing the authentication when the one-time password M corresponds with the response password N;
a short message service (SMS) server for converting the query(a) transmitted from the OTP server into a text message including the query(a) and transmitting the generated text message;
an OTP terminal for detecting the query(a) in the transmitted text message from the SMS server and generating and displaying the response password N;
a personal communications device for transmitting the response password N to the OTP server when the response password N corresponding to the transmitted query(a) from the OTP server is input; and
a content offer server for providing to the personal communications device content corresponding according to the authentification.

2. The one-time password service system of claim 1,
wherein the OTP server and the OTP terminal each use a hashing function to generate the one-time password M and the response password N, respectively.

3. The one-time password service system of claim 2,
wherein the hashing function h(a, b) has a factor “a” which corresponds to information including the query(a) and “b” which corresponds to unique information including a identifying information(b) of the OTP terminal.

4. The one-time password service system of claim 3,
wherein the unique identifying information(b) includes information corresponding to a phone number of the OTP terminal.

5. The one-time password service system of claim 4,
wherein the OTP server includes:
a query generator for generating the query(a) when authentication requirement information corresponding to the content is received from the content offer server;
a password generator for generating the one-time password M using the query(a) and the identifying information(b) of the OTP terminal;
an authenticator for performing the authentication when the one-time password M corresponds with the response password N generated in the OTP mobile phone and transmitted through the personal communications device; and
a controller for transmitting the query(a) to the personal communications device and the SMS server, and transmitting the results of the authentication to the content offer server.

6. The one-time password service system of claim 5,
wherein the OTP server further includes:
an user database for managing registered user information in the content offer server including the identifying information(b)of the OTP terminal;
a content server database for controlling information included in the contents offer server; and
a SMS server database for controlling information included in the SMS server, wherein the controller controls the generation and transmission of the query(a) and the generation and authentication of the one-time password M based on information stored in the user, content server and SMS server databases.

7. The one-time password service system of claim 4,
wherein the generated text message includes an identification value for indicating that the text message includes the query(a).

8. The one-time password service system of claim 7,
wherein the OTP terminal includes:
a text message idenitificator for determining the generated text message's type based on the identification value, and determining whether the generated text message includes the query(a);
a query detector for detecting the query(a) from the generated text message when the query(a) is included in the generated text message;
a password generator for generating the response password N using the hashing function; and
a display unit for displaying the response password N.

9. The one-time password service system of claim 7,
wherein the content offer server includes:
a content offerer for providing the corresponding content to the personal communication device according to the authentification;
a content manager for controlling the content;
a user manager for managing user information including the identifying information(b) of the registered user in the content offer server; and
an authentification manager for determining the authentication required for the corresponding content, managing information required for the authentication, and transmitting information corresponding to the authentication to the OTP server.

10. A method of authentication using a one-time password (OTP) service system, the method comprising:
generating a query(a) for an authentication required to provide content in an OTP server, transmitting the query(a) to a personal communications device and to an SMS (short message service) server, and generating a one-time password M by using the query(a);
transforming, in the SMS server, the query(a) transmitted from the OTP server into a text message including the query(a), and transmitting the text message to an OTP terminal;
detecting, in the OTP terminal, the query(a) included in the text message transmitted from the SMS server, and generating a response password N using the query(a);
transmitting the response password N into the OTP server when the response password N is inputted to the personal communications device;
receiving, in the OTP server, the response password N to perform the authentication when the response password N is corresponds with the one-time password M; and
selectively, in the content offer server, providing corresponding content to the personal communications device according to the authentication.

11. The method of claim 10, wherein the one-time password M and the response password N are generated using a hashing function h(a,b) in the OTP server and the OTP terminal, respectively.

12. The method of claim 11, wherein the hashing function h(a, b) has a factor “a” which corresponds to information including the query(a) and “b” which corresponds to unique information including the identifying information allocated to the OTP terminal.

13. The method of claim 12, wherein the identifying information(b) includes information corresponding to a phone number of the OTP terminal.

14. A mobile phone capable of generating an one-time password (OTP), the mobile phone comprising:
a text message idenitificator for determining a type of a text message by using an identification value included in the text message when the text message is transmitted from a short message service (SMS) server, and determining whether the text message includes a query(a);
a query detector for detecting the query(a) from the text message when it is determined that the query(a) is included in the text message;
a password generator for generating a response password N corresponds to the detected query(a) and identifying information(b)allocated to the OTP mobile phone; and
a display unit for displaying the response password N.

15. The mobile phone of claim 14,
wherein the one-time password N is generated by using a hashing function h(a, b) where “a” corresponds to information including the query(a) and “b” corresponds to unique information including identifying information(b).

16. The mobile phone of claim 15,
wherein the identifying information(b) includes information corresponding to phone number of the OTP mobile phone.
